(19) United States
(12) Patent Application Publication
(10) Pub. No.: US 2020/0025518 A1
(43) Pub. Date: Jan. 23, 2020

(54) REFLEX SIGHT WITH CANT INDICATING RETICLE DISPLAY

(71) Applicant: Wilcox Industries Corp., Newington, NH (US)

(72) Inventors: Michael C. Nackel, Manchester, NH (US); Richard Wengenroth, Pembroke, NH (US); Marvin S. Carter, III, Rochester, NH (US); Andrew Nicholson, Methuen, MA (US); Jansen J. Habrial, Brookfield, NH (US)

(21) Appl. No.: 16/354,500

(22) Filed: Mar. 15, 2019

Related U.S. Application Data
(60) Provisional application No. 62/644,180, filed on Mar. 16, 2018.

(51) Int. Cl. F41G 1/44; F41G 1/30; G02B 27/01

(52) U.S. Cl. CPC F41G 1/44; F41G 1/38; G02B 27/0101; F41G 1/30

(57) ABSTRACT

In one aspect, a sighting device for a weapon includes an orientation sensor configured to detect a weapon cant, a display having one or more visual indicators, and a processor. The processor is configured to receive information regarding weapon cant from the orientation sensor and is further configured to control the one or more visual indicators of the display output to provide a visual indication of excessive weapon cant. In a further aspect, a method of sighting a target is provided.

### CROSS-REFERENCE TO RELATED APPLICATION

This application claims the priority benefit of U.S. provisional application Ser. No. 62/644,180 filed Mar. 16, 2018. The aforementioned provisional application is incorporated herein by reference in its entirety.

### BACKGROUND

The present development relates to a weapon sight. The invention will be described herein primarily by way of reference to weapon accessory having a reflex or red dot sight and, in particular, to an improved reflex sight with cant indication within the projected reticle. It will be recognized however that the present development may be embodied in all manner of weapon sights, including magnifying rifle scopes employing refractive optics. The sighting device herein may be a standalone reflex sight, or, may be weapon accessory device or system, such as a laser aiming or targeting device, ballistics fire control system, or the like, having a reflex sight as a component thereof. The present development may advantageously be used in connection with a firearm such as a rifle and will be described herein primarily by way of reference thereto. However, it will be recognized that the present development is amenable for use with any type of projectile device that needs to be aimed and has a ballistic curve that would cause lower accuracy without repeatable cant, including without limitation, firearms, rifles, shot guns, archery bows, grenade launchers, mortars, howitzers, catapults, and so forth.

A red dot sight is a type of reflex sight for firearms or other devices for firing a projectile, and finds widespread use for military, law enforcement, hunting, and target shooting applications. Such sights provide an illuminated aim point in the form of a dot displayed on a partially reflective screen, the aim point coinciding with the point of impact of the projectile fired by an associated weapon. Such sights commonly use a red light-emitting diode (LED) (although other colors, such as green, are also known) at the focus of collimating optics that eliminate or reduce the effect of parallax.

It is well known that tilting or canting a weapon about the viewing axis of the sight, even a few degrees, will cause the point of impact to deviate from a fired projectile to impact. Existing anti-canting solutions indicate cant in various ways, such as with bubble level or light/LED cant indicators disposed in places other than the reticle such as the target periphery or on an accessory housing. See for example, commonly owned U.S. Pat. No. 8,100,044, incorporated herein by reference in its entirety. Commonly, such cant indicators require the user to take his or her eyes off the target scene. Other known cant indicators that are in the user's field of vision when viewing the target area are disposed at a different focal plane than the target scene, which requires the user to refocus his or her eyes to see the cant indication, which means that they lose situational awareness downfield near the target. For example, a typical red dot reticle is projected to focal plane which is similar to the distance to a target (for example, from about 300 to 3000 feet), whereas, a cant indication is typically displayed at the focal plane of the aiming device (for example, typically 1 to 2 feet).

The present development provides a visual cant indication that is visually close to or, in certain embodiments, part of, an illuminated reticle pattern which does not require the user to take his or her eyes off the targeted scene and which projects the cant indication to a focal plane which is similar to the distance to the target area and, therefore, does not require the user to refocus his or her eyes to view.

### SUMMARY

In one aspect, a sighting device for a weapon includes a viewing window through which a user can view a target scene and an orientation sensor for generating information representative of a weapon cant angle. A processor is in electrical communication with the orientation sensor and configured to receive the information representative of the weapon cant angle from the orientation sensor. A display is in electrical communication with the processor for providing a visual indication of excessive weapon cant if the weapon cant angle exceeds a preselected threshold. Projection optics project an image of the display viewable through the viewing window.

In a more limited aspect, the projection optics include a partially reflective screen disposed in the viewing window, the partially reflective screen configured to reflect the image of the display while permitting visualization of the target scene therethrough.

In another more limited aspect, the projection optics are configured to project the image of the display to be perceived at a focal plane located at a distance in front of the viewing screen such that the image of the display will appear in focus to an eye of a person observing the target scene through the viewing window without the need to refocus the eye. In certain embodiments, the distance to the focal plane is approximately equal to a distance to the target scene. In certain embodiments, the distance to the focal plane is in the range of about 100 feet to optical infinity. In certain embodiments, the distance to the focal plane is in the range of about 300 feet to about 1000 feet.

In yet another more limited aspect, the orientation sensor is selected from the group consisting of 2-axis analog accelerometer, 3-axis analog accelerometer, 2-axis digital accelerometer, 3-axis digital accelerometer, magnetometer, mercury switch, and rolling ball switch. In certain embodiments, the orientation sensor is an analog accelerometer and the processor includes an analog-to-digital converter for creating a digital representation of an analog output signal from the accelerometer.

In another more limited aspect, the processor is selected from the group consisting of microprocessor, microcontroller, programmable logic device, complex programmable logic device, field programmable gate array, and field programmable object array.

In still another more limited aspect, the display includes a plurality of pixels for displaying an image.

In another more limited aspect, the image is an aiming reticle. In certain embodiments, the reticle includes a left reticle element disposed to the left of a central aim point, and a right reticle element disposed to the right of the central aim point.

In yet another more limited aspect, the reticle further includes an upper reticle element disposed above the central aim point and a lower reticle element disposed below the central aim point. In certain embodiments, the central aim point is an illuminated dot, and the upper reticle element, right reticle element, lower reticle element, and left reticle element are selected from the group consisting of arc shaped segments and cross hair elements.

In certain embodiments, the central aim point is an illuminated dot, and the upper reticle element, right reticle element, lower reticle element, and left reticle element are arc shaped segments cooperating to define a segmented circle. In another more limited aspect, the processor is configured to cause the left reticle element and the right reticle element to be displayed in non-contrasting fashion when the weapon cant angle is less than a preselected threshold cant angle, and to cause the left reticle element to be displayed in a contrasting fashion when the weapon cant angle is greater than a preselected threshold cant angle to the left, and to cause the right reticle element to be displayed in a contrasting fashion when the weapon cant angle is greater than a preselected threshold cant angle to the right.

In yet another more limited aspect, the preselected threshold cant angle is selected from the group consisting of 2 degrees, 4 degrees, and 6 degrees.

In still another more limited aspect, the processor is configured to cause the left reticle element and a right reticle element to be displayed in non-blinking fashion when the weapon cant angle is less than a preselected threshold cant angle, to cause the left reticle element to be displayed in a blinking fashion when the weapon cant angle is greater than a preselected threshold cant angle to the left, and to cause the right reticle element to be displayed in a blinking fashion when the weapon cant angle is greater than a preselected threshold cant angle to the right.

In another more limited aspect, the reticle further includes one or more directional indicia which are illuminated when the weapon cant angle is greater than a preselected threshold cant angle, the directional indicia providing a visual indication of a direction of rotation of the weapon to bring the weapon cant angle to within the preselected cant angle.

In another more limited aspect, a first left reticle element disposed to the left of a central aim point, a second left reticle element disposed intermediate the central aim point and the first left reticle element, a first right reticle element disposed to the right of the central aim point, and a second right reticle element disposed intermediate the central aim point and the second right reticle element; the processor is configured to cause the first left reticle element, second left reticle element, the first right reticle element, and the second right reticle element to be displayed in non-contrasting fashion when the weapon cant angle is less than a first preselected threshold cant angle; the processor is configured to cause the second left reticle element to be displayed in a contrasting fashion when the weapon cant angle is greater than the first preselected threshold cant angle to the left; the processor is configured to cause the second right reticle element to be displayed in a contrasting fashion when the weapon cant angle is greater than the first preselected threshold cant angle to the right; the processor is configured to cause the first left reticle element to be displayed in a contrasting fashion when the weapon cant angle is greater than a second preselected threshold cant angle to the left, wherein the second preselected threshold angle is greater than the first preselected threshold angle; and the processor is configured to cause the first right reticle element to be displayed in a contrasting fashion when the weapon cant angle is greater than the second preselected threshold cant angle to the right.

In another aspect, a method of sighting a target in a target area includes viewing a target area through viewing window and detecting a weapon cant angle with an orientation sensor. Using a processor, it is determined whether the weapon cant angle exceeds a preselected cant angle. An image is generated on a display, the image including an aim point and a plurality of reticle elements. The image is projected using projection optics so that it is viewable through the viewing window. If the weapon cant angle exceeds a preselected threshold, a visual indication of excessive weapon cant is displayed.

In a more limited aspect, the projection optics include a partially reflective screen disposed in the viewing window, the partially reflective screen configured to reflect the image of the display while permitting visualization of the target scene therethrough.

In another more limited aspect, the image of the display is projected to be perceived at a focal plane located at a distance in front of the viewing screen such that the image of the display will appear in focus to an eye of a person observing the target scene through the viewing window without the need to refocus the eye. In certain embodiments, the distance to the focal plane is approximately equal to a distance to the target scene. In certain embodiments, the distance to the focal plane is in the range of about 100 feet to optical infinity. In certain embodiments, the distance to the focal plane is in the range of about 300 feet to about 1000 feet.

In another more limited aspect, the plurality of reticle elements includes a left reticle element and a right reticle element. In certain embodiments, the left reticle element and a right reticle element are displayed in non-contrasting fashion when the weapon cant angle is less than a preselected threshold cant angle, the left reticle element is displayed in a contrasting fashion when the weapon cant angle is greater than a preselected threshold cant angle to the left, and the right reticle element is displayed in a contrasting fashion when the weapon cant angle is greater than a preselected threshold cant angle to the right.

In certain aspects, an aiming system and weapon accessory device incorporating same includes a sighting assembly as described herein. In certain embodiments, an orientation sensor is configured to detect a weapon cant, and a display system is provided having one or more visual indicators. A processor is configured to receive cant information regarding the weapon cant from the orientation sensor and is further configured to control the one or more visual indicators of the display system to provide a visual indication of the weapon cant.

In a more limited aspect, the sighting assembly includes a reflex sight and a reticle display. In certain embodiments, the reticle display is operable in a partial reticle mode. In certain embodiments, the display system further includes a reflex lens for reflecting a user-perceivable image.

In another more limited aspect, the reflex sight includes a reflex lens configured to collimate light rays from the display system. In certain embodiments, the reflex lens is a dichroic screen. In certain embodiments, the reticle display includes a center aim point and at least two visual indicators, each of the at least two visual indicators being disposed on opposing sides of the center aim point. In certain embodiments, the reticle display includes a center aim point and four visual indicators, the four visual indicators disposed in a geometric configuration around the center aim point.

In a more limited aspect, the processor is pre-programmed with a threshold cant angle. In certain embodiments, the threshold cant angle is selected from the group consisting of 2 degrees, 4 degrees, and 6 degrees. In certain embodiments, the visual indication of the status of the weapon cant is representative of a weapon cant exceeding the threshold cant angle. In certain embodiments, the visual indication of the status of the weapon cant is representative of a directionally excessive cant status selected from “left” and “right.” In certain embodiments, the visual indication of the status of the weapon cant is representative of a weapon cant being within the threshold cant angle, i.e., in a proper positioning for firing a projective with the weapon.

In another more limited aspect, the plurality of reticle elements includes a first left reticle element disposed to the left of a central aim point, a second left reticle element disposed intermediate the central aim point and the first left reticle element, a first right reticle element disposed to the right of the central aim point, and a second right reticle element disposed intermediate the central aim point and the second right reticle element; causing the first left reticle element, second left reticle element, the first right reticle element, and the second right reticle element to be displayed in non-contrasting fashion when the weapon cant angle is less than a first preselected threshold cant angle; causing the second left reticle element to be displayed in a contrasting fashion when the weapon cant angle is greater than the first preselected threshold cant angle to the left; causing the second right reticle element to be displayed in a contrasting fashion when the weapon cant angle is greater than the first preselected threshold cant angle to the right; causing the first left reticle element to be displayed in a contrasting fashion when the weapon cant angle is greater than a second preselected threshold cant angle to the left, wherein the second preselected threshold angle is greater than the first preselected threshold angle; and causing the first right reticle element to be displayed in a contrasting fashion when the weapon cant angle is greater than the second preselected threshold cant angle to the right.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1A is an isometric view of an exemplary weapon accessory device employing a reflex and aiming sight in accordance with an exemplary embodiment of the invention.

FIG. 1B is a schematic view of the display system and optics for directing the visual output of the integrated reticle and cant indicator to an eye of the user.

FIG. 2A illustrates a first exemplary reticle display embodiment with integrated cant indicator wherein the weapon is a substantially horizontal position and, therefore, is in a proper position for firing.

FIG. 2B depicts the reticle display of FIG. 2A, wherein the weapon is canted right and, therefore, is not in a proper position for firing.

FIG. 2C depicts the reticle display of FIG. 2A, wherein the weapon is canted left and, therefore, is not in a proper position for firing.

FIG. 3A illustrates a second exemplary reticle display embodiment with integrated cant indicator wherein the weapon is a substantially horizontal position and, therefore, is in a proper position for firing.

FIG. 3B depicts the reticle display of FIG. 3A, wherein the weapon is canted right and, therefore, is not in a proper position for firing.

FIG. 3C depicts the reticle display of FIG. 3A, wherein the weapon is canted left and, therefore, is not in a proper position for firing.

FIG. 4A illustrates a third exemplary reticle display embodiment with integrated cant indicator wherein the weapon is a substantially horizontal position and, therefore, is in a proper position for firing.

FIG. 4B depicts the reticle display of FIG. 4A, wherein the weapon is canted right and, therefore, is not in a proper position for firing.

FIG. 4C depicts the reticle display of FIG. 4A, wherein the weapon is canted left and, therefore, is not in a proper position for firing.

FIG. 5A illustrates a fourth exemplary reticle display embodiment with integrated cant indicator wherein the weapon is a substantially horizontal position and, therefore, in a proper position for firing.

FIG. 5B depicts the reticle display of FIG. 5A, wherein the weapon is canted right and, therefore, is not in a proper position for firing.

FIG. 5C depicts the reticle display of FIG. 5A, wherein the weapon is canted left and, therefore, is not in a proper position for firing.

FIGS. 6A-6C illustrate an exemplary “full reticle” display mode for a reflex sight, similar the embodiment of FIGS. 2A-2C and which is selectable as one of multiple operational mode.

FIGS. 7A-7C illustrate an exemplary “red dot only” display mode for a reflex sight wherein an integrated cant indicator display segment is not displayed unless the degree of cant to the right (FIG. 7B) or left (FIG. 7C) exceeds some preselected or predetermined threshold amount.

FIGS. 8A-8C illustrate an exemplary “partial reticle” display mode for a reflex sight, similar the embodiment of FIGS. 4A-4C and which is selectable as one of multiple operational mode.

FIG. 9 depicts a further embodiment reticle display similar to the display of FIGS. 2A-2C, but wherein multiple cant thresholds are provided.

FIG. 10 depicts a further embodiment reticle display similar to the display of FIGS. 3A-3C, but wherein multiple cant thresholds are provided.

FIGS. 11A-11C depicts a further embodiment wherein the cant indicating display has directionally shaped display elements.

FIG. 12 is block diagram of the cant indicating reticle display system herein.

### DETAILED DESCRIPTION OF THE PREFERRED EMBODIMENTS

As used herein, the term “cant” means rotation or tilt of a firearm or other weapon about the axis of the barrel of the weapon. A zero degree cant means that the weapon is in a perfectly vertical position. A right cant means that the top of the weapon is tilted toward the right side from the perspective of the user. A left cant means that the top of the weapon is tilted toward the left side from the perspective of the user.

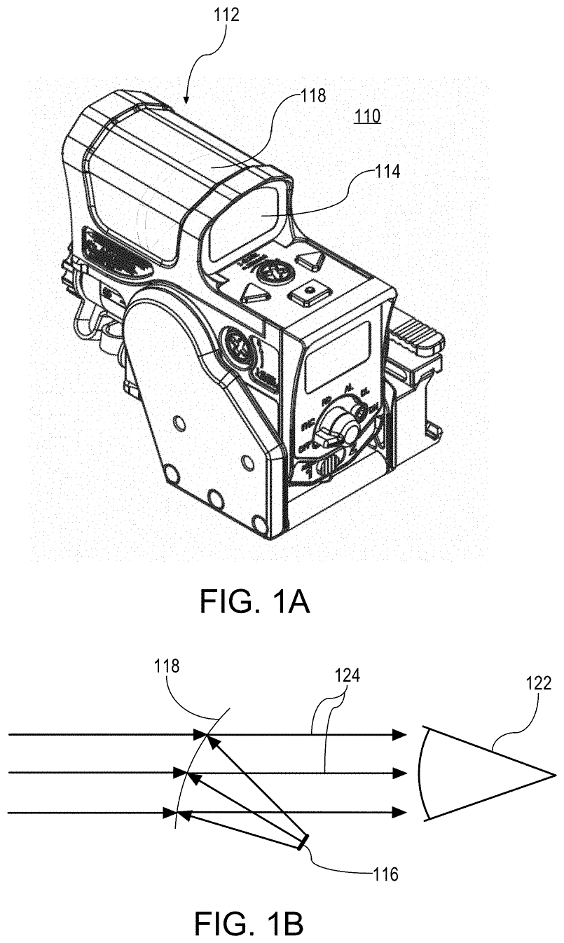

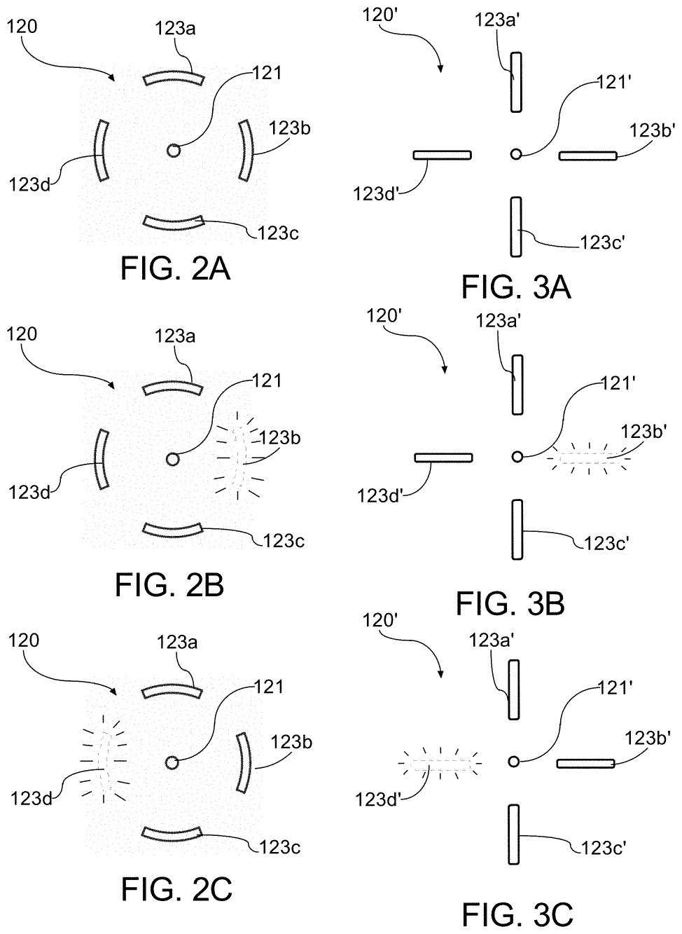

Referring now to FIG. 1A, there appears an exemplary weapon accessory device 110 having a reflex sight 112 operable to embody the present invention, which includes a window 114 for visualizing a target scene as well as a display 116 for displaying an aiming reticle 120 (see, e.g., FIGS. 2A-2C). The display includes a partially reflective or dichroic screen 118 for reflecting the monochromatic projected display image to an eye 122 of the user while allowing other wavelengths from the target scene to pass through. The reflex lens 118, e.g., a concave dichroic screen, is provided to project the image to be perceived at a focal plane which is some distance in front of the user. In certain embodiments, the image is projected to a distance of from about 100 feet to optical infinity. In certain embodiments, the image is projected to a distance of from about 300 feet to about 1000 feet. As illustrated in FIG. 1B, by collimating the light rays 124 from the display so that they are substantially parallel when they reach the user's eye, the user can focus his or her eyes on the target area and the reticle 120 at the same time. It will be recognized that other reflective, refractive, and/or diffractive optical elements may be employed to project, direct, and/or steer the output of the display 116 to the eye of the user. Although the display will be described herein by way of reference to a dedicated reticle display with integrated cant indicator, it will be recognized that the cant indicating display in accordance with the present development can also be configured to display other information, such as battery status information, range to target, super elevation, ammunition type or status, device status, weapon status, communications link status, and so forth. Although the development is described herein by way of reference to the presently preferred embodiment employing a red dot of reflex sight, it will be recognized that the present development is also amenable to a magnifying rifle scope having a reticle and employing refractive optics wherein cant indicia are displayed to appear at the focal of the scope in combination with the existing reticle of the scope.

As best seen in FIG. 12, the reticle display system in accordance with the present disclosure consists of three main components, namely, a tilt sensor 130, a processor 134 (including an associated memory for storing a program of instructions), and the display output 116. The display system 116 includes display driving circuitry, which may be implemented in control logic running on the processor 134 or as a separate hardware display driver module. The tilt sensor 130 may be an accelerometer, such as a commercially available accelerometer. The tilt sensor 130 measures the orientation of the reflex sight 112, and may be an analog or digital, 2-axis or 3-axis accelerometer. For example, in certain embodiments, the accelerometer may be a 2- or 3-axis, analog accelerometer, which outputs a signal 132 for each axis of the accelerometer that is read into the processor 134, e.g., using an internal analog-to-digital converter (ADC) on the processor 134. In an alternative embodiment, a dedicated ADC (not shown) may be employed to create a digital representation of an analog output signal 132, for example, in the case of an analog accelerometer where the processor 134 does not have an on-chip ADC. In preferred embodiments, a digital accelerometer 130 is used, preferably a three-axis digital accelerometer, which provides a number of advantages such as improved cost, noise immunity, and power operating range.

In still further embodiments, a magnetometer may be provided as the tilt sensor 130, to sense the earth's magnetic field in 3 axes. This is advantageous in sensing rotation about a vertical axis, although the accuracy may decrease as compared to an accelerometer. In another embodiment, the tilt sensor may be a mercury switch or rolling ball switch.

The output signal 132 representative of the angular orientation of the reflex sight 112, which as noted above may be a digital or analog signal, is output by the tilt sensor 130 to a processor 134. The processor 134 may be a microprocessor, microcontroller, or other device, such as a programmable logic device (PLD), complex programmable logic device (CPLD), field programmable gate array (FPGA), field programmable object array (FPOA), or the like. The processor 132 may be a commercially available processor capable of fetching and executing computer instructions. The processor 134 is also preferably one that also has additional peripheral functions integrated into it, including support functions necessary to operate it, a configurable clock source, a memory such as a random access memory (RAM), and read-only memory (ROM). Although the tilt sensor 130 and the processor 134 are depicted as discrete components, it will be recognized that the present development could also be implemented, for example, using a solid-state accelerometer on-chip processing facilities or a microprocessor with an integrated solid-state accelerometer.

In operation, a display signal 136 is generated based on sensed inclination data from the accelerometer 132 by the processor 134 and sent to the display 116 for controlling the segments of the display to be illuminated. The display may be, for example, an LED display, LCD display, spatial light modulator, micro-electromechanical device, and so forth. FIGS. 2A-2C illustrate an exemplary reticle display comprising a center dot 121 (aim point), and upper, right, lower, and left arc-shaped segments 123a, 123b, 123c, and 123d, respectively, disposed in a geometric configuration around the aim point.

In certain embodiments, the center dot 121 is generated by a separate dedicated LED (not shown) and the segments 123a-123d are generated by addressable segments or pixels (or groups of segments or pixels) of the display 116. Alternatively, the center dot 121 is a segment or pixel (or groups of segments or pixels) of the display 116.

The processor 134 receives the signal 132 from tilt sensor 130 and determines whether the degree of tilt, e.g., relative to a vertical or horizontal axis, is less than some preselected threshold amount. In certain embodiments, the threshold angle is selected to be 6 degrees, preferably 4 degrees, and more preferably 2 degrees, although any other threshold angle may be selected, for example, based on one or more factors such as weapon type, range to target, ammunition type, and so forth.

Referring to FIGS. 2A-2C, if the tilt is within the predetermined threshold, the processor 134 outputs a display signal illuminating the center dot 121 and all four of the reticle components or segments 123a-123d are illuminated in steady, non-blinking, and non-contrasting fashion as shown in FIG. 2A. If the processor 134 determines that the unit 112 is canted to the left (i.e., counter clockwise rotation), by an amount greater than the predetermined threshold, the processor outputs a display signal illuminating the center dot 121 and three of the reticle components or segments 123a-123c are illuminated in steady or non-blinking fashion, and the segment 123d in a blinking, non-steady, or otherwise contrasting fashion, as shown in FIG. 2B. If the processor determines that the unit 112 is canted to the right (i.e., clockwise rotation), by an amount greater than the predetermined threshold, the processor outputs a display signal illuminating the center dot 121 and three of the reticle components or segments 123a, 123c, and 123d are illuminated in steady or non-blinking fashion, and the segment 123b in a blinking, non-steady, or otherwise contrasting fashion, as shown in FIG. 2C.

The present development will be described herein by way of reference to the presently preferred embodiment of using a blinking reticle segment to provide a visual indication of excessive cant, however, it will be recognized that alternative visual indications other than an on-off blinking pattern can also be used and are equally applicable to the embodiment of FIGS. 2A-2C as well as the other embodiments disclosed herein. Indications of excessive cant that can be used in place of a blinking display segment include pulsing or modulating the intensity of a segment, changing the color of a segment, changing the shape of a segment, animating an icon or segment, turning the segment on or off altogether, illuminating the segment at a different (e.g., lower or higher) steady state intensity relative to the other segments, and so forth.

For brevity, the embodiments herein will be described primarily by way of reference to the use of a blinking reticle component to indicate the presence and direction of cant, but the alternative methods noted above for indicating cant are equally applicable to each of the embodiments, and are incorporated into descriptions thereof by reference.

In each of the embodiments appearing in FIGS. 2-10, the cant indicating element that is actuated appears on the corresponding side of the reticle in the reflex sight field of view. For example, in the case of a right cant, the cant is indicated using a pixel or segment (or group thereof) on the right side of the field of view and vice versa. In such embodiments, where there is excessive cant to the right (clockwise) the cant indicating element(s) on the right side of the reticle indicate that the weapon needs to be rotated counterclockwise by raising the right side. Similarly, where there is excessive cant to the left (counterclockwise) the cant indicating element(s) on the left side of the reticle indicate that the weapon needs to be rotated clockwise by raising the left side.

However, it will be recognized that, in alternative embodiments, the cant indicating element(s) indicating excessive cant to the right could appear on the left side of the reflex sight field of view and the cant indicating element(s) indicating excessive cant to the right could appear on the left side of the reflex sight field of view. In such embodiments, where there is excessive cant to the right (clockwise) the cant indicating element(s) would appear on the left side of the reticle indicate that the weapon needs to be rotated counterclockwise by lowering the left side. Similarly, where there is excessive cant to the left (counterclockwise) the cant indicating element(s) on the right side of the reticle indicate that the weapon needs to be rotated clockwise by lowering the right side. Thus, for each of the embodiments appearing in FIGS. 2-10, the side that the cant indicating element(s) appear on could be reversed, i.e., wherein the right cant indication appears on the left side of the reticle and wherein the left cant indication appears on the right side of the reticle.

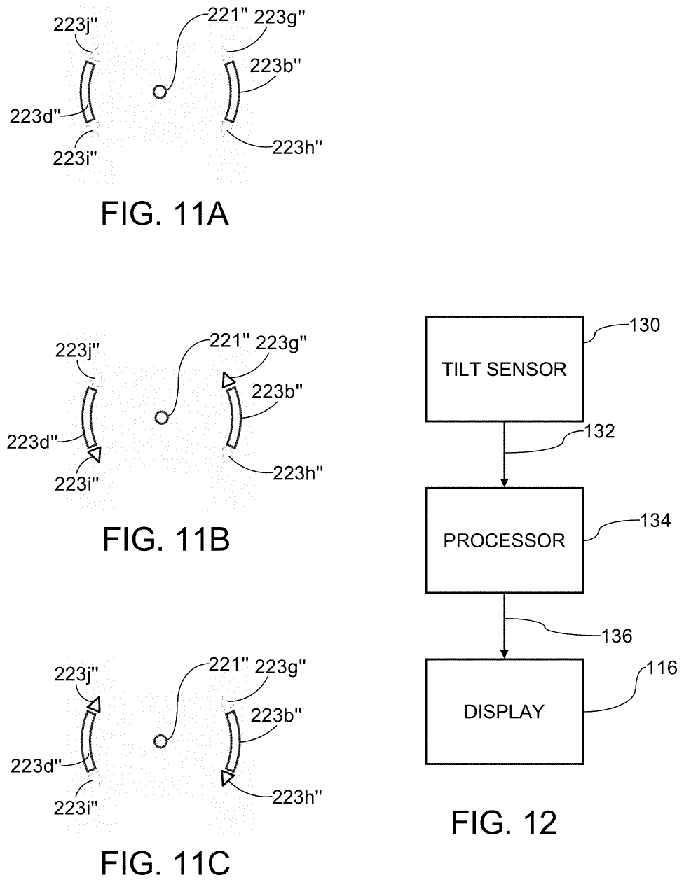

In certain embodiments, the addressable segments/pixels of the display may be have a directional shape such as an arrow. An exemplary embodiment of such appears in FIGS. 11A-11C.

In certain embodiments that involve blinking, pulsing, or other modulation of a segment, the rate of such blinking, pulsing, or other modulation may be a function of the degree of cant. For example, the rate of such blinking, pulsing, or other modulation may increase with increasing cant and vice versa. Alternatively, in other embodiments the rate of such blinking, pulsing, or other modulation does not vary with the degree of cant so that the display indicates the cant direction only.

Referring to FIGS. 3A-3C, an embodiment 120′ similar to that shown in FIGS. 2A-2C is illustrated, except wherein a center dot 121′ depicts the aim point and four cross-hair type reticle components or segments 123a′-123d′ are provided. When the cant is less that the predetermined threshold, all of the segments 123a′-123d are illuminated in steady, non-blinking, and non-contrasting fashion as shown in FIG. 3A. If the processor 134 determines that the unit 112 is canted to the left (i.e., counter clockwise rotation), by an amount greater than the predetermined threshold, the processor outputs a display signal illuminating the center dot 121′ and three of the reticle components or segments 123a′-123c′ are illuminated in steady or non-blinking fashion, and the segment 123d′ in a blinking, non-steady, or otherwise contrasting fashion, as shown in FIG. 3B. If the processor determines that the unit 112 is canted to the right (i.e., clockwise rotation), by an amount greater than the predetermined threshold, the processor outputs a display signal illuminating the center dot 121′ and three of the reticle components or segments 123a′, 123c′, and 123d′ are illuminated in steady or non-blinking fashion, and the segment 123b′ in a blinking, non-steady, or otherwise contrasting fashion, as shown in FIG. 3C.

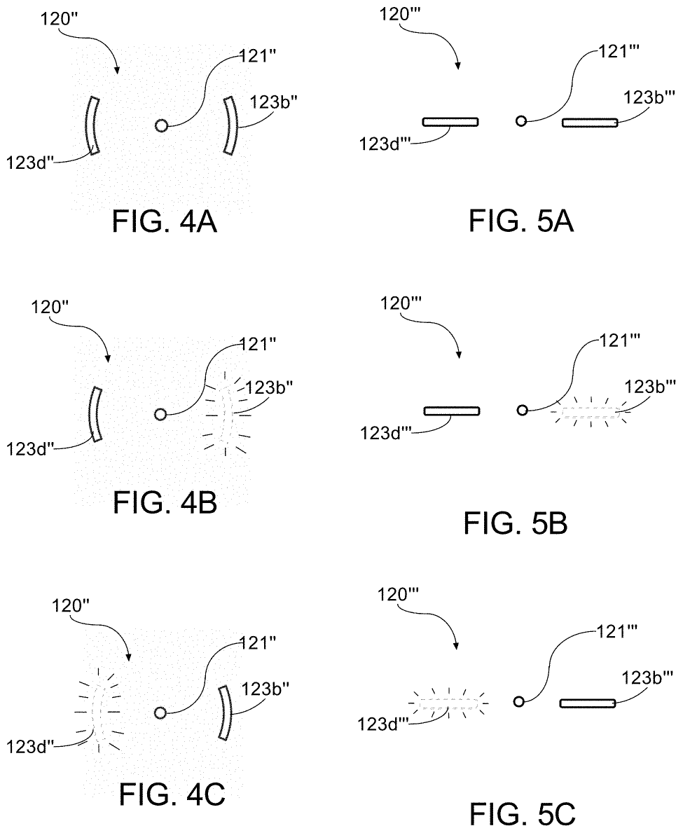

Referring to FIGS. 4A-4C, an embodiment 120′ similar to that shown in FIGS. 2A-2C is illustrated, except wherein a center dot 121″ depicts the aim point and two arc-shaped reticle components or segments 123b″ and 123d″ are provided. When the cant is less that the predetermined threshold, both of the segments 123b″ and 123d″ are illuminated in steady, non-blinking, and non-contrasting fashion, as shown in FIG. 4A. If the processor 134 determines that the unit 112 is canted to the left (i.e., counter clockwise rotation), by an amount greater than the predetermined threshold, the processor outputs a display signal illuminating the center dot 121″ and the reticle segments 123b″ is illuminated in steady or non-blinking fashion, and the segment 123d″ in a blinking, non-steady, or otherwise contrasting fashion, as shown in FIG. 4B. If the processor determines that the unit 112 is canted to the right (i.e., clockwise rotation), by an amount greater than the predetermined threshold, the processor outputs a display signal illuminating the center dot 121″ and the reticle segments 123d″ is illuminated in steady or non-blinking fashion, and the segment 123b″ in a blinking, non-steady, or otherwise contrasting fashion, as shown in FIG. 4C.

Referring to FIGS. 5A-5C, an embodiment 120′″ similar to that shown in FIGS. 4A-4C is illustrated, except wherein a center dot 121′″ depicts the aim point and two horizontal reticle components or segments 123b′″ and 123d′″ are provided. When the cant is less that the predetermined threshold, both of the segments 123b′″ and 123d′″ are illuminated in steady, non-blinking, and non-contrasting fashion as shown in FIG. 5A. If the processor 134 determines that the unit 112 is canted to the left (i.e., counter clockwise rotation), by an amount greater than the predetermined threshold, the processor outputs a display signal illuminating the center dot 121′″ and the reticle segments 123b′″ is illuminated in steady or non-blinking fashion, and the segment 123d′″ in a blinking, non-steady, or otherwise contrasting fashion, as shown in FIG. 5B. If the processor determines that the unit 112 is canted to the right (i.e., clockwise rotation), by an amount greater than the predetermined threshold, the processor outputs a display signal illuminating the center dot 121′″ and the reticle segments 123d′″ is illuminated in steady or non-blinking fashion, and the segment 123b′″ in a blinking, non-steady, or otherwise contrasting fashion, as shown in FIG. 5C.

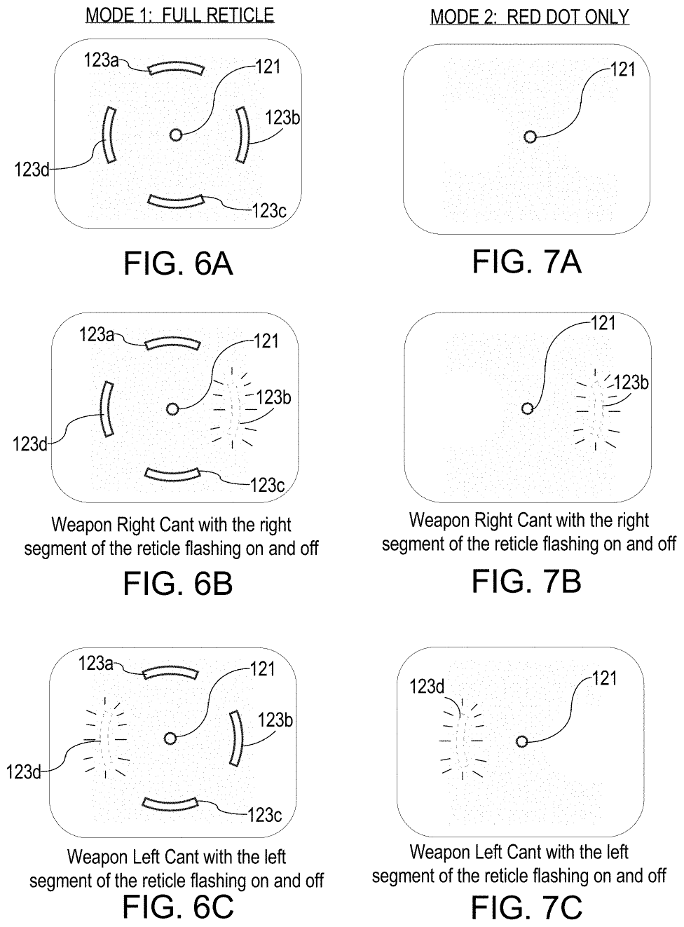

Referring now to FIGS. 6A-6C, FIGS. 7A-7C, and 8A-8C, there are illustrated exemplary modes of operating a reflex sight with integrated cant indicator in the field of view having multiple (e.g., 2, 3, 4, or more) user-selectable modes of operation. The modes are selectable via a selector switch on the unit or, alternatively, via a screen or menu option on an associated device such as an associated laser targeting device, ballistics computer, fire control system, or the like. Three operating modes are shown, and it will be recognized that a reflex sight in accordance with this disclosure may incorporate all three modes as a user selectable option. However, it will be recognized that one- and two-mode reflex sight configurations are also contemplated employing any combination of the three illustrated modes, e.g., mode 1 and mode 2, mode 1 and mode 3, and mode 2 and mode 3, mode 1 only, mode 2 only, and mode 3 only.

In certain embodiments, a sighting device herein has three modes of operation as summarized in the Table 1 below:

TABLE 1

| FIG. | Mode | Description |
|---|---|---|
| 6A | Mode 1: Full Reticle | Weapon Cant within preselected threshold |
| 6B | Mode 1: Full Reticle | Weapon Right Cant with the right |
| | | segment of the reticle flashing on and off |
| 6C | Mode 1: Full Reticle | Weapon Left Cant with the left segment |
| | | of the reticle flashing on and off |
| 7A | Mode 2: Red Dot Only | Weapon Cant within preselected threshold |
| 7B | Mode 2: Red Dot Only | Weapon Right Cant with the right |
| | | segment of the reticle flashing on and off |
| 7C | Mode 2: Red Dot Only | Weapon Left Cant with the left segment |
| | | of the reticle flashing on and off |
| 8A | Mode 3: Partial Reticle | Weapon Cant within preselected threshold |
| 8B | Mode 3: Partial Reticle | Weapon Right Cant with the right |
| | | segment of the reticle flashing on and off |
| 8C | Mode 3: Partial Reticle | Weapon Left Cant with the left segment |
| | | of the reticle flashing on and off |

In a first mode, illustrated in FIGS. 6A-6C, the display is operated in a “full reticle” mode, which is as described above by way of reference to FIGS. 2A-2C, wherein the cant indication is displayed in the context of the full reticle. In alternative embodiments, the reticle arc segments 123a-123d could be replaced with other shapes, such as the cross hair type segments shown in FIGS. 3A-3C.

In a second mode, illustrated in FIGS. 7A-7C, the display is operated in a “red dot only” mode, wherein the center dot 121 is displayed with no reticle segment displayed when the weapon is in a proper level position for firing as shown in FIG. 7A. When the weapon is canted right (FIG. 7B), a right reticle segment 123b appears. When the weapon is canted left (FIG. 7C), a left reticle segment 123d appears. In certain embodiments, the segments 123b, 123d are illuminated to indicate right and left cant, respectively. In certain embodiments, the segments 123b, 123d are illuminated and caused to blink, pulse, modulate, etc., as described above to indicate right and left cant, respectively. In alternative embodiments, the reticle arc segments 123b, 123d could be replaced with other shapes, such as the linear segments shown in FIGS. 5A-5C.

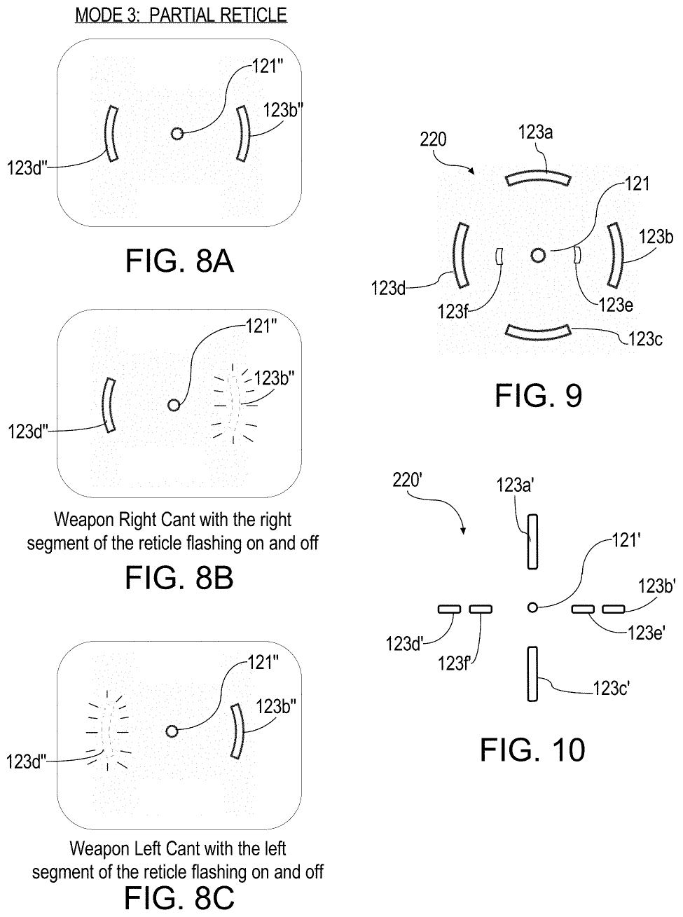

In a third mode, illustrated in FIGS. 8A-8C, the display is operated in a “partial reticle” mode, which is as described above by way of reference to FIGS. 4A-4C, wherein the cant indication is displayed in the context of a partial reticle. In alternative embodiments, the reticle arc segments 123b and 123d could be replaced with other shapes, such as the linear segments shown in FIGS. 5A-5C.

Referring now to FIG. 9, there appears a further embodiment reticle display 220 comprising a center dot 121, and upper, right, lower, and left arc-shaped segments 123a, 123b, 123c, and 123d, respectively, disposed in a geometric configuration around the aim point. The display 220 is as otherwise as described above by way of reference to FIGS. 2A-2C, except that it has an additional right cant indicator reticle segment 123e intermediate the center dot 121 and the segment 123b. For example, the outermost cant indicator segments 121b and 121d may be caused to blink, pulse, modulate, change shape, etc., by the processor when the degree of cant to the right and left, respectively, is greater than some first preselected cant angle. One of the intermediate cant indicator segments 123e and 123f may be actuated when the cant angle, to the right and left, respectively, is less than the first preselected cant angle but greater than a second preselected cant angle.

Referring now to FIG. 10, there appears a further embodiment reticle display 220′ comprising a center dot 121′, and upper, right, lower, and left linear segments 123a′, 123b′, 123c′, and 123d′, respectively, disposed in a geometric configuration around the aim point. The display 220′ is as otherwise as described above by way of reference to FIGS. 3A-3C, except that it has an additional right cant indicator reticle segment 123e′ intermediate the center dot 121′ and the segment 123b′. For example, the outermost cant indicator segments 121b′ and 121d′ may be caused to blink, pulse, modulate, change shape, etc., by the processor when the degree of cant to the right and left, respectively, is greater than some first preselected cant angle. One of the intermediate cant indicator segments 123e′ and 123f′ may be actuated when the cant angle, to the right and left, respectively, is less than the first preselected cant angle but greater than a second preselected cant angle.

In certain embodiments, the first threshold angle for the embodiments of FIGS. 9 and 10 is 6 degrees and the second threshold angle is 3 degrees. In preferred embodiments, the first threshold angle for the embodiments of FIGS. 9 and 10 is 4 degrees and the second threshold angle is 2 degrees. Again, it will be recognized that any other threshold angles may be selected, for example, based on one or more factors such as weapon type, range to target, ammunition type, and so forth although other preselected angle thresholds are contemplated.

It will be recognized that further embodiments having other numbers of cant indicator segments besides 1 or 2, e.g., 3, 4, 5, 6, 7, 8, 9, 10, 11, 12, or more, which additional segments correspond to cant threshold values, are also contemplated and that the single cant threshold embodiments of FIGS. 2A-8C can be can be adapted for multiple cant thresholds by providing additional display segments. In certain embodiments, multiple left and right cant indicator segments are provided to provide a graduated cant level indicator, as will be described in greater detail below.

Referring now to FIGS. 11A-11C, there is shown an exemplary embodiment having directional reticle components. The embodiment of FIGS. 11A-11C comprises a center dot 221″, and right and left arc-shaped segments 223b″ and 223d″, respectively, disposed on opposing sides the aim point 221″. The display is as otherwise as described above by way of reference to FIGS. 2A-2C, except that it has an additional upper right cant indicator reticle segment 223g″, lower right cant indicator reticle segment 223h″, lower left cant indicator reticle segment 223i″, and upper left cant indicator reticle segment 223j″. The segments 223g″-223j″ are directional in shape, e.g., arrowhead shaped.

In FIG. 11A, the weapon is in a horizontal position suitable for firing and each of the segments 223g″-223j″ is “off.” In FIG. 11B, the segments 223g″ and 223i″ are “on” and 223h″ and 223j″ are “off,” indicating an excessive cant to the right. The activated segments are directional, thereby providing a visual indication of the direction (i.e., counterclockwise) the weapon needs to be rotated to bring it into a horizontal position.

In FIG. 11C, the segments 223g″ and 223i″ are “off” and 223h″ and 223j″ are “on,” indicating an excessive cant to the left. The activated segments are directional, thereby providing a visual indication of the direction (i.e., clockwise) the weapon needs to be rotated to bring it into a horizontal position.

In embodiments employing directional cant indicator elements, it will be recognized that the significance of the directional elements could be reversed. For example, instead of indicating the direction of rotation of the weapon needed to effect a correction of the excessive cant, the directional elements could be used to indicate the direction of the cant. For example, in such embodiments, the elements in 223g″ and 223i″ in FIG. 11B would indicate that the weapon is canted to the left (clockwise), and the elements in 223h″ and 223j″ in FIG. 11C would indicate that the weapon is canted to the right (counterclockwise).

In certain embodiments, each of the display configurations appearing in FIGS. 2A-2C, 3A-3C, 4A-4C, 5C-5C, 6A-6C, 7A-7C, and 8A-8C are configured as binary, on/off cant indicators, for providing a visual indication as to whether the cant is within a preselected threshold, which is sufficient for many aiming scenarios. However, for various reasons, not all aiming scenarios or ballistics or firing solutions (for example, ballistics computation performed by a ballistics computer or otherwise) are at zero cant. In certain aiming scenarios, a ballistics solution may factor the cant into the solution and if the cant is non-zero, it would be desirable to ensure that the particular non-zero cant is maintained or can be reproduced when firing a projectile with the weapon based on the firing solution. As noted above, in certain embodiments, a plurality of cant indicating elements, e.g., dots, dashes, arcs, arrows, or other cant-indicating indicia are provided to provide a graduated level of cant indication, e.g., wherein more elements being illuminated indicating more cant. In certain embodiments, the display 116 may comprise a LED or LCD pixel array with a sufficient pixel resolution to achieve the desired cant resolution.

In further embodiments, a cant indicator with a relatively small number cant indicating elements can be adapted to provide a graduated cant indication, wherein a blink or pulse rate of the cant indicating elements is varied as a function of the cant level. In certain embodiments, a faster blink of pulse rate indicates a higher degree of cant. In certain embodiments, the cant display may be as shown and described by way of reference to FIGS. 2A-2C, but wherein the blink or pulse rate of the cant indicating elements 123d, 123b varies as a function of cant. In certain embodiments, the cant display may be as shown and described by way of reference to FIGS. 3A-3C, but wherein the blink or pulse rate of the cant indicating elements 123d′, 123b′ varies as a function of cant. In certain embodiments, the cant display may be as shown and described by way of reference to FIGS. 4A-4C, but wherein the blink or pulse rate of the cant indicating elements 123d″, 123b″ varies as a function of cant. In certain embodiments, the cant display may be as shown and described by way of reference to FIGS. 5A-5C, but wherein the blink or pulse rate of the cant indicating elements 123d′″, 123b′″ varies as a function of cant. In certain embodiments, the cant display may be as shown and described by way of reference to FIGS. 6A-6C, but wherein the blink or pulse rate of the cant indicating elements 123d, 123b varies as a function of cant. In certain embodiments, the cant display may be as shown and described by way of reference to FIGS. 7A-7C, but wherein the blink or pulse rate of the cant indicating elements 123d, 123b varies as a function of cant. In certain embodiments, the cant display may be as shown and described by way of reference to FIGS. 8A-8C, but wherein the blink or pulse rate of the cant indicating elements 123d″, 123b″ varies as a function of cant. In certain embodiments, the cant display may be as shown and described by way of reference to FIG. 9, but wherein the blink or pulse rate of the cant indicating elements 123d, 123b varies as a function of cant. In certain embodiments, the cant display may be as shown and described by way of reference to FIG. 10, but wherein the blink or pulse rate of the cant indicating elements 123d, 123b varies as a function of cant. In certain embodiments, the cant display may be as shown and described by way of reference to FIGS. 11A-11C, but wherein the blink or pulse rate of one or more of the cant indicating elements 223d″, 223b″, 223j″, 223g″, 223i″, 223h″ varies as a function of cant.

In still further embodiments, the display 116 provides a numerical output of cant, e.g., in degrees or other units. In such embodiments, the cant indication may be a numerical indication only or may include the cant indicator display elements as shown and descried above by way of reference or FIGS. 2A-11C.

In alternative embodiments, a sighting device with a cant display without the center aim point is provided. In such embodiments, the center aim point is omitted, but the sighting device may be as otherwise shown and described herein. In certain embodiments, the cant display may be as shown and described by way of reference to FIGS. 2A-2C, but wherein the center aim point (121) is omitted. In certain embodiments, the cant display may be as shown and described by way of reference to FIGS. 3A-3C, but wherein the center aim point (121′) is omitted. In certain embodiments, the cant display may be as shown and described by way of reference to FIGS. 4A-4C, but wherein the center aim point (121″) is omitted. In certain embodiments, the cant display may be as shown and described by way of reference to FIGS. 5A-5C, but wherein the center aim point (121′″) is omitted. In certain embodiments, the cant display may be as shown and described by way of reference to FIGS. 6A-6C, but wherein the center aim point (121) is omitted. In certain embodiments, the cant display may be as shown and described by way of reference to FIGS. 7A-7C, but wherein the center aim point (121) is omitted. In certain embodiments, the cant display may be as shown and described by way of reference to FIGS. 8A-8C, but wherein the center aim point (121″) is omitted. In certain embodiments, the cant display may be as shown and described by way of reference to FIG. 9, but wherein the center aim point (121) is omitted. In certain embodiments, the cant display may be as shown and described by way of reference to FIG. 10, but wherein the center aim point (121′) is omitted. In certain embodiments, the cant display may be as shown and described by way of reference to FIGS. 11A-11C, but wherein the center aim point (221″) is omitted. Embodiments wherein the center aim point is omitted may advantageously be employed in conjunction with a laser aiming or targeting device which is coaligned with the cant indicating sighting device as described herein.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A sighting device for a weapon, the sighting device comprising:
a viewing window through which a user can view a target scene;
an orientation sensor for generating information representative of a weapon cant angle;
a processor in electrical communication with the orientation sensor, the processor configured to receive the information representative of the weapon cant angle from the orientation sensor;
a display in electrical communication with the processor for providing a visual indication of excessive weapon cant if the weapon cant angle exceeds a preselected threshold; and
projection optics for projecting an image of the display, the image of the display viewable through the viewing window.

2. The sighting device of claim 1, wherein the projection optics include a partially reflective screen disposed in the viewing window, the partially reflective screen configured to reflect the image of the display while permitting visualization of the target scene therethrough.

3. The sighting device of claim 1, wherein the projection optics are configured to project the image of the display to be perceived at a focal plane located at a distance in front of the viewing screen such that the image of the display will appear in focus to an eye of a person observing the target scene through the viewing window without the need to refocus the eye.

4. The sighting device of claim 3, wherein the distance to the focal plane is approximately equal to a distance to the target scene.

5. The sighting device of claim 3, wherein the distance to the focal plane is in the range of about 100 feet to optical infinity.

6. The sighting device of claim 3, wherein the distance to the focal plane is in the range of about 300 feet to about 1000 feet.

7. The sighting device of claim 1, wherein the orientation sensor is selected from the group consisting of 2-axis analog accelerometer, 3-axis analog accelerometer, 2-axis digital accelerometer, 3-axis digital accelerometer, magnetometer, mercury switch, and rolling ball switch.

8. The sighting device of claim 1, wherein the orientation sensor is an analog accelerometer and the processor includes an analog-to-digital converter for creating a digital representation of an analog output signal from the accelerometer.

9. The sighting device of claim 1, wherein the processor is selected from the group consisting of microprocessor, microcontroller, programmable logic device, complex programmable logic device, field programmable gate array, and field programmable object array.

10. The sighting device of claim 1, wherein the display includes a plurality of pixels for displaying an image.

11. The sighting device of claim 10, wherein the image is an aiming reticle.

12. The sighting device of claim 11, wherein the reticle comprises a central aim point, a left reticle element disposed to the left of the central aim point, and a right reticle element disposed to the right of the central aim point.

13. The sighting device of claim 12, wherein the reticle further comprises an upper reticle element disposed above the central aim point and a lower reticle element disposed below the central aim point.

14. The sighting device of claim 13, wherein the central aim point is an illuminated dot, and wherein the upper reticle element, right reticle element, lower reticle element, and left reticle element are selected from the group consisting of arc shaped segments and cross hair elements.

15. The sighting device of claim 13, wherein the central aim point is an illuminated dot, and wherein the upper reticle element, right reticle element, lower reticle element, and left reticle element are arc shaped segments cooperating to define a segmented circle.

16. The sighting device of claim 12, wherein the processor is configured to cause the left reticle element and the right reticle element to be displayed in non-contrasting fashion when the weapon cant angle is less than a preselected threshold cant angle, and to cause the left reticle element to be displayed in a contrasting fashion when the weapon cant angle is greater than a preselected threshold cant angle to the left, and to cause the right reticle element to be displayed in a contrasting fashion when the weapon cant angle is greater than a preselected threshold cant angle to the right.

17. The sighting of claim 16, wherein the preselected threshold cant angle is selected from the group consisting of plus or minus 2 degrees from a vertical weapon orientation, plus or minus 4 degrees from the vertical weapon orientation, and plus or minus 6 degrees from the vertical weapon orientation.

18. The sighting device of claim 12, wherein the processor is configured to cause the left reticle element and a right reticle element to be displayed in non-blinking fashion when the weapon cant angle is less than a preselected threshold cant angle, to cause the left reticle element to be displayed in a blinking fashion when the weapon cant angle is greater than a preselected threshold cant angle to the left, and to cause the right reticle element to be displayed in a blinking fashion when the weapon cant angle is greater than a preselected threshold cant angle to the right.

19. The sighting device of claim 12, wherein the reticle further comprises one or more directional indicia which are illuminated when the weapon cant angle is greater than a preselected threshold cant angle, the directional indicia providing a visual indication of a direction of rotation of the weapon to bring the weapon cant angle to within the preselected cant angle.

20. The sighting device of claim 11, wherein:
a first left reticle element disposed to the left of a central aim point, a second left reticle element disposed intermediate the central aim point and the first left reticle element, a first right reticle element disposed to the right of the central aim point, and a second right reticle element disposed intermediate the central aim point and the second right reticle element;
the processor is configured to cause the first left reticle element, second left reticle element, the first right reticle element, and the second right reticle element to be displayed in non-contrasting fashion when the weapon cant angle is less than a first preselected threshold cant angle;
the processor is configured to cause the second left reticle element to be displayed in a contrasting fashion when the weapon cant angle is greater than the first preselected threshold cant angle to the left;
the processor is configured to cause the second right reticle element to be displayed in a contrasting fashion when the weapon cant angle is greater than the first preselected threshold cant angle to the right;
the processor is configured to cause the first left reticle element to be displayed in a contrasting fashion when the weapon cant angle is greater than a second preselected threshold cant angle to the left, wherein the second preselected threshold angle is greater than the first preselected threshold angle; and
the processor is configured to cause the first right reticle element to be displayed in a contrasting fashion when the weapon cant angle is greater than the second preselected threshold cant angle to the right.

21. A method of sighting a target in a target area, comprising:
viewing a target area through viewing window;
detecting a weapon cant angle with an orientation sensor;
determining, using a processor, whether the weapon cant angle exceeds a preselected cant angle;
generating, on a display, an image including an aim point and a plurality of reticle elements;
projecting, using projection optics, the image of the display so that it is viewable through the viewing window; and
if the weapon cant angle exceeds a preselected threshold, displaying a visual indication of excessive weapon cant.

22. The method of claim 21, wherein the projection optics include a partially reflective screen disposed in the viewing window, the partially reflective screen configured to reflect the image of the display while permitting visualization of the target scene therethrough.

23. The method of claim 21, wherein the image of the display is projected to be perceived at a focal plane located at a distance in front of the viewing screen.

24. The method of claim 23, wherein the distance to the focal plane is approximately equal to a distance to the target scene.

25. The method of claim 23, wherein the distance to the focal plane is in the range of about 100 feet to optical infinity.

26. The method of claim 23, wherein the distance to the focal plane is in the range of about 300 feet to about 1000 feet.

27. The method of claim 21, wherein the plurality of reticle elements includes a left reticle element and a right reticle element, the method further comprising:
causing the left reticle element and a right reticle element to be displayed in non-contrasting fashion when the weapon cant angle is less than a preselected threshold cant angle;
causing the left reticle element to be displayed in a contrasting fashion when the weapon cant angle is greater than a preselected threshold cant angle to the left; and
causing the right reticle element to be displayed in a contrasting fashion when the weapon cant angle is greater than a preselected threshold cant angle to the right.

28. The method of claim 21, further comprising:
the plurality of reticle elements includes a first left reticle element disposed to the left of a central aim point, a second left reticle element disposed intermediate the central aim point and the first left reticle element, a first right reticle element disposed to the right of the central aim point, and a second right reticle element disposed intermediate the central aim point and the second right reticle element;
causing the first left reticle element, second left reticle element, the first right reticle element, and the second right reticle element to be displayed in non-contrasting fashion when the weapon cant angle is less than a first preselected threshold cant angle;
causing the second left reticle element to be displayed in a contrasting fashion when the weapon cant angle is greater than the first preselected threshold cant angle to the left;
causing the second right reticle element to be displayed in a contrasting fashion when the weapon cant angle is greater than the first preselected threshold cant angle to the right;
causing the first left reticle element to be displayed in a contrasting fashion when the weapon cant angle is greater than a second preselected threshold cant angle to the left, wherein the second preselected threshold angle is greater than the first preselected threshold angle; and
causing the first right reticle element to be displayed in a contrasting fashion when the weapon cant angle is greater than the second preselected threshold cant angle to the right.
